(19) United States
(12) Patent Application Publication
(10) Pub. No.: US 2017/0165868 A1
(43) Pub. Date: Jun. 15, 2017

(54) TUBES HAVING MEASUREMENT LINES AND METHODS FOR USE

(71) Applicant: Terry A. Falldorf, Lewisburg, OH (US)

(72) Inventor: Terry A. Falldorf, Lewisburg, OH (US)

(73) Assignee: Terry A. Falldorf, Lewisburg, OH (US)

(21) Appl. No.: 14/595,242

(22) Filed: Jan. 13, 2015

(51) Int. Cl. B28B 7/00; B28B 11/24; B28B 7/34; G01B 3/00; B28B 1/14

(52) U.S. Cl. CPC B28B 7/0002; G01B 3/004; B28B 1/14; B28B 7/34; B28B 11/243

(57) ABSTRACT

Disclosed is a tube comprising an outer surface, an inner surface, a lumen defined by the inner surface, and circumferential lines disposed on the outer surface of the tube. In certain embodiments, the circumferential lines serve as measurement guides to select a desired length, and to accurately and cleanly cut the tube to a desired length. In other embodiments, diametrically opposed lines are disposed on the tube in pairs, thereby allowing a user to locate a point on the tube 180 degrees away from a given point. In certain embodiments, the tube may be used to create cylindrical columns. In certain embodiments, concrete is poured into the lumen of the tube to form concrete columns. In alternative embodiments, the tube is used as a guide to cut pipes to a desired length.

### BACKGROUND OF THE INVENTION

Field of the Invention

Disclosed is a tube with lines disposed on the outer surface. The lines are spaced at certain distances to provide points of measurement positioning. In certain embodiments, the tubes serve as guides to allow a user to cut the tube to a desired size without the need to apply additional markings on the tube. In alternative embodiments, the tubes are pipes with measurement lines disposed directly on the tube to facilitate easy measurement and to provide a guide for uniform cutting of the pipe. In other embodiments, lines are positioned along the tube in pairs, with each line diametrically opposed to the other, with a distance between the two lines defined by the diameter of the tube. The tube has utility in construction applications when used to form concrete columns, but also has utility in any application wherein a hollow tube must be cut to a desired size. Further, certain embodiments of the tube enable a user to precisely drill through the diameter of a tube or column to a point on the opposite side of the tube. Certain embodiments of the tube are designed to have utility in any application wherein a liquid or semi-liquid is poured into a cylindrical mold before hardening.

Related Art

Tubes are widely used in various applications. One challenge associated with the use of tubes is the need to accurately measure the tubes for use. Tubes, including pipes, must often be cut to an appropriate size.

Cylindrical tubes for forming concrete columns are known in the art. Such tubes are often made of cardboard. Concrete is poured into such cylindrical tubes and the tube serves as a mold for the concrete.

One limitation of the tubes presently available is the range of sizes available. Because the length of concrete columns required in construction applications varies, it is often necessary for the tubes to be cut before use. Typically a user of such a tube will select a tube having a longer length than necessary, and then cut the tube to the desired size. This process necessitates the need for measuring instruments to measure the desired length of the tube, and the need for a marking instrument to mark the desired length. Another instrument is often needed to circumferentially mark the tube so it can be uniformly cut to size. Measuring and marking the correct dimensions is a time consuming process. Further, uniformly marking a circumferential line on the tube is difficult with the instruments typically available at a construction site.

### SUMMARY OF THE INVENTION

Disclosed is a tube having one or more or more lines disposed on the outer surface for measurement or as a reference point. In certain embodiments, the disclosed tube has utility in for forming cylindrical columns and method of use. The tubes disclosed comprise one or more parallel circumferential lines disposed on the outer surface of the tube. The lines may differ in appearance. In certain embodiments, the lines may vary by color and width. Additionally, some embodiments may include lines that may be broken lines, or lines formed by a series of letters, numbers, or symbols. Further, some embodiments may include lines that have sections of alternating color or shading to depict letters or logos.

Lines of similar type (such as color or width) are spaced in regular intervals along the length of the tube and represent fixed lengths. Lines may be placed at each inch, centimeter, or at any other unit of measurement or at any multiple or fraction of any unit of measurement. In certain embodiments, lines may be printed on the outer surface of the tube with ink. In alternative embodiments, the lines are embossed onto the outer surface of the tube.

Certain embodiments also include one or more pairs of diametrically opposed lines, running along the length of the tube. The diametrically opposed lines may be disposed on the outer surface of the tube, on the inner surface of the tube, or on both surfaces. Each diametrically opposed line of a pair is placed at 180 degrees from each other. In embodiments having more than one pair of diametrically opposed lines, each pair may be have a distinct color, width, or may include lines that may be broken lines, or lines formed by a series of letters, numbers, or symbols.

Certain embodiments of the tube are composed of a material that is easy to cut, and that will be rigid enough to support a column formed by a liquid or semiliquid material poured into the lumen of the tube. In certain embodiments, the tube is made from cardboard. In certain embodiments, non-corrugated cardboard is used to ensure a uniform and smooth finish of the resulting column. In alternative embodiments, other rigid materials may be used.

Alternative embodiments of the tube comprise a pipe having lines to facilitate easy cutting and placement during installation. Such pipes may be composed of any material. Certain embodiments of the pipes will comprise pipes composed of metal, metal alloys, plastic, polyvinyl chloride, or any similar material.

In certain embodiments, the inner surface of the tube may be coated with a material to enable fast removal of the tube and to prevent the tube from sticking to the finished column.

The tubes are used by determining the desired length of the tube. A line on the tube, at the desired length, is then selected by a user, and the tube is then cut along the line.

In embodiments where the tube will be the tube is then placed vertically on a surface. Concrete, or another liquid or semiliquid material, is then poured into the tube and allowed to harden.

The diametrically opposed lines serve as guides when it is necessary for a user to know the precise location of a diametrically opposed point on the tube. These lines can be used to guide a user when drilling through a column or pipe when the entry and exit points of the drill must be diametrically opposed and spaced at a distance defined by the diameter of the tube.

An alternative method for is to use the tubes as a guide to cut pipes. In such methods, a tube having a diameter slightly larger than a pipe is placed on the pipe. The tube is then used a guide to cut the pipe. This method eliminates the need to mark the pipe. Finally, in certain embodiments, a pipe may have lines disposed directly onto the pipe to facilitate measurement and cutting of the pipe without the use of additional instruments for measurement.

### BRIEF DESCRIPTION OF THE DRAWINGS

FIG. 1 is an illustration of a representative tube having circumferential measurement lines disposed on the outer surface.

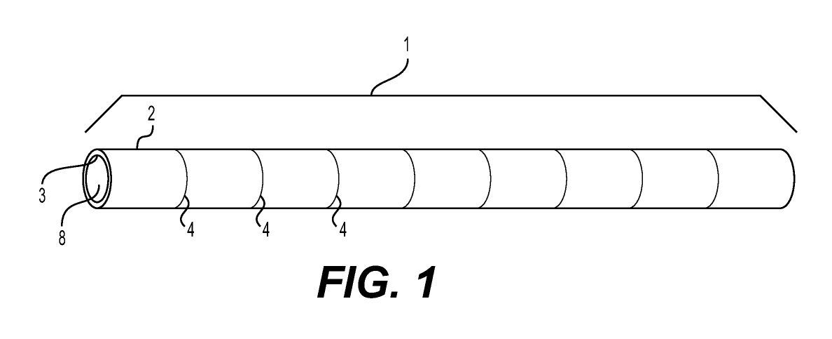

FIG. 2 is an illustration of a representative embodiment of a tube having vertical, diametrically opposed lines disposed its outer surface.

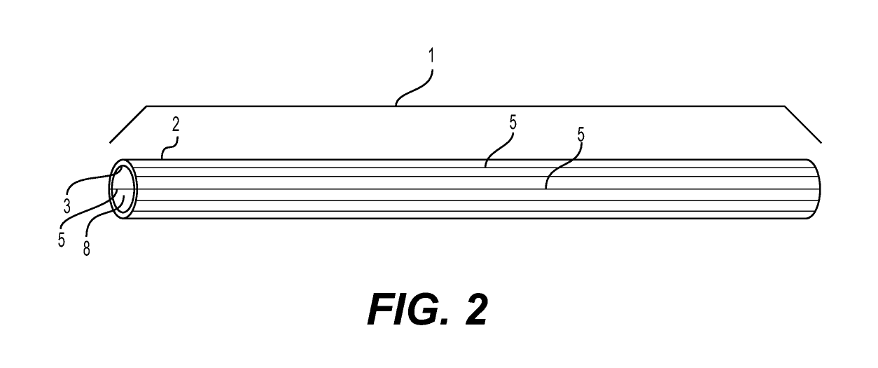

FIG. 3 is an illustration of a representative embodiment of a tube having both circumferential measurement lines and diametrically opposed vertical lines disposed on its outer surface.

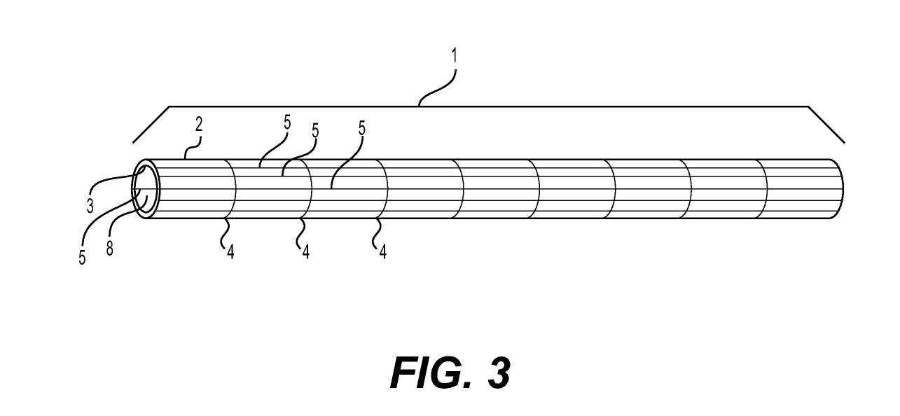

FIG. 4 is an illustration of a representative embodiment of a method of using a tube for forming cylindrical columns.

FIG. 5 is an illustration of a representative embodiment of a method of using a tube as a measuring guide for cutting a pipe.

### DETAILED DESCRIPTION OF VARIOUS EXEMPLARY EMBODIMENTS OF THE PRESENT INVENTION

Disclosed is tube 1. The tube 1 has an outer surface 2 and an inner surface 3. The tube has lines disposed on the outer surface 2. The tube 1 may have one or more circumferential lines 4 disposed on the outer surface 2, or pairs of diametrically opposed vertical lines 5 running perpendicular to the circumferential lines 4. Disposed on the outer surface 2 are one or more circumferential lines 4. The circumferential lines 4 are disposed at regular linear distances. The circumferential lines 4 may be placed at distances measured in inches, centimeters, or any other unit of measurement, multiple of a unit of measurement, or fraction of a unit of measurement. The circumferential lines 4 and the diametrically opposed vertical lines 5 may be disposed on the outer surface 2 of the tube 1, the inner surface 3 of the tube 1, or may be disposed on both the inner surface 3 and outer surface 2 of the tube 1. Additionally, the circumferential lines 4 and diametrically 5 opposed vertical lines may be used in combination or individually.

In certain embodiments, the circumferential lines 4 may vary in appearance according to the unit or distance each line represents. In certain embodiments, the circumferential lines 4 may be of varying colors, have varying widths, be dotted or solid, or comprised of letters, numbers, or symbols. In such embodiments, the differences in the appearance of the circumferential lines 4 define separate types of circumferential lines 4. A tube may have one or more types of circumferential lines 4. One embodiment of a type of circumferential lines 4 is color. In such an embodiment, each type of circumferential line 4 will be identified by a specific color, with each color defining a distance or unit of measure between circumferential lines 4 of the same type. For example, a tube 4 may have a blue circumferential line disposed every two inches and a red circumferential line disposed every five inches. Thus the blue circumferential line defines one type of circumferential line and the red line defines another type of circumferential line. Alternatively, types of circumferential lines 4 may be defined by differing widths of the circumferential lines 4. In certain embodiments, the circumferential lines are disposed on the outer surface 2 with ink or paint. In alternative embodiments, the circumferential lines 4 are embossed onto the outer surface. In certain embodiments, shading or colors of the circumferential lines 4 may be altered to depict letters, numbers, or a logo, when the tube is viewed at a distance.

Certain embodiments of the tube may comprise one or more pairs of diametrically opposed lines 5 running along the length of the outer surface 2 of the tube 1. In alternative embodiments, diametrically opposed lines 5 may be disposed on the inner surface 3 of the tube, or may be disposed on both, the inner surface 3 and outer surface 2. In embodiments wherein a one or more pairs of diametrically opposed lines included on the outer surface 3 of the tube 1 with circumferential lines 4, the diametrically opposed lines 5 are perpendicular to the circumferential lines 4. Each diametrically opposed line 5 in a pair is positioned 180 degrees away from the other. The distance between the each diametrically opposed line 5 in a pair is defined by the diameter of the tube. In embodiments including more than one pair of diametrically opposed lines 5, each pair may be of a distinct type. In such embodiments, the differences in the appearance of the diametrically opposed lines define separate types of diametrically opposed lines 5. One embodiment of a type of circumferential lines 4 is color. In such an embodiment, each type of diametrically opposed lines 5 will be identified by a specific color, with each color defining a unique pair of diametrically opposed lines 5. Alternatively, types of diametrically opposed lines 5 may be defined by differing widths of the circumferential lines 5. In certain embodiments, the diametrically opposed lines 5 are disposed on the outer surface 2 with ink or paint. In alternative embodiments, the diametrically opposed lines are embossed onto the outer surface 2.

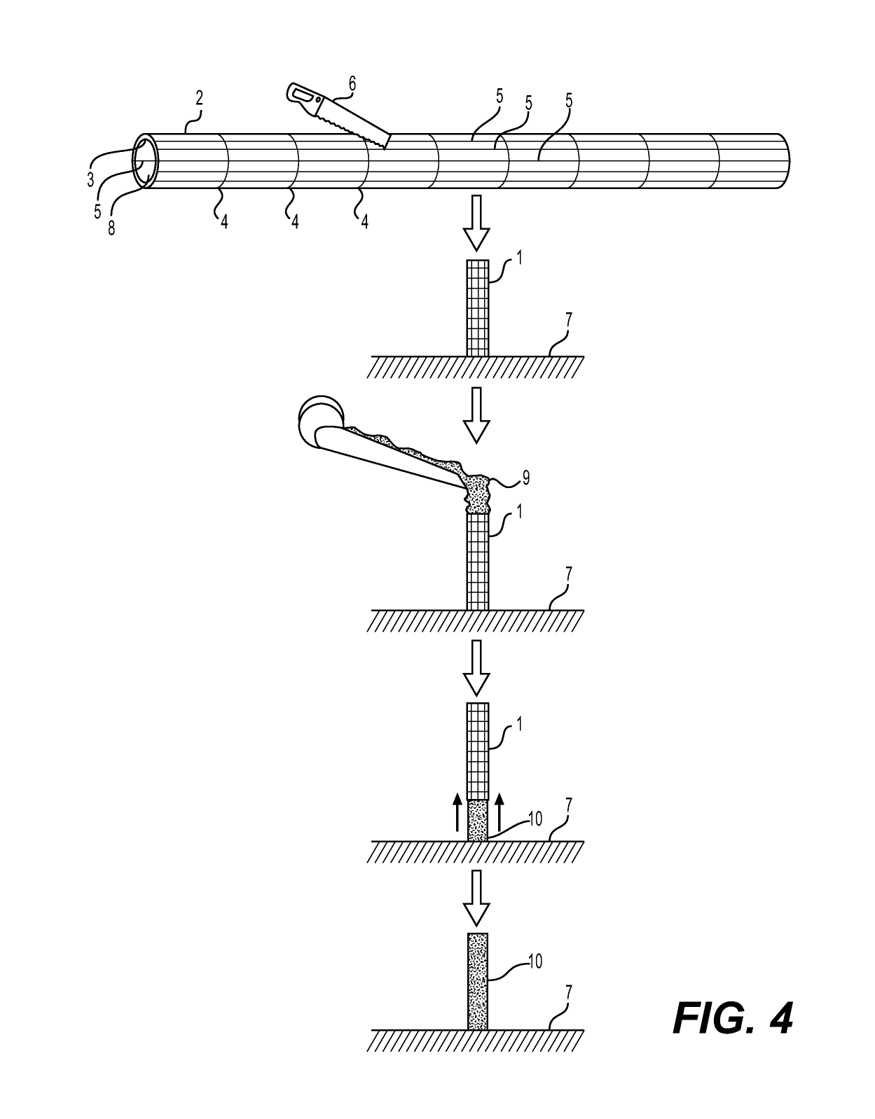

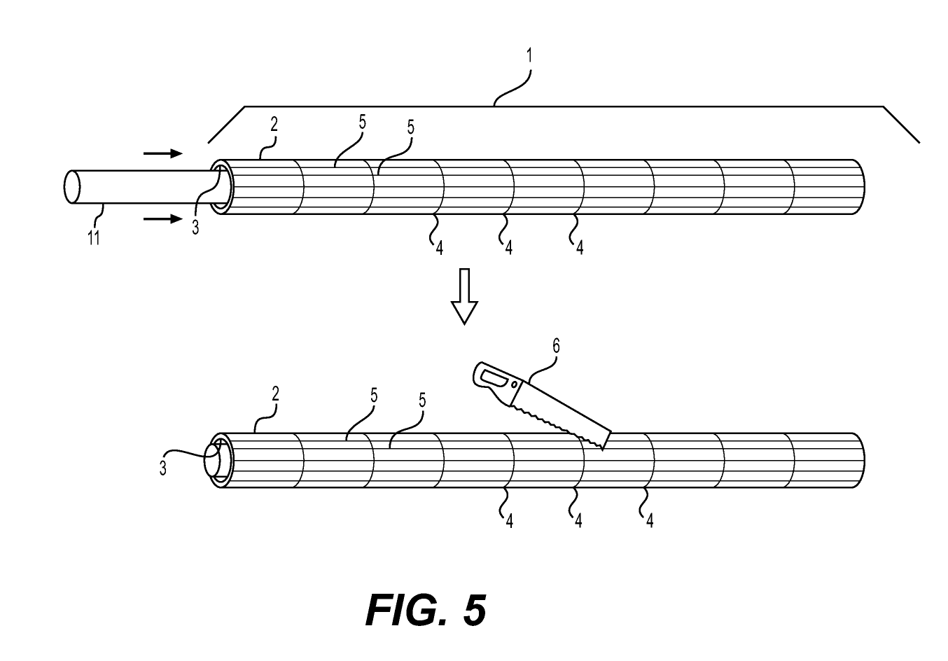

In certain embodiments, the tube 1 may be composed of a rigid material that is easy to cut with instruments readily available to those working in construction and home improvement. Any suitable cutting instrument may be used to cut the tube 1. For example, FIG. 4 and FIG. 5 depict a saw 6 being used to cut the tube 1. Such instruments include, but are not limited to, power saws, gas cut off saws, knives, and scissors. In certain embodiments, the tube 1 is composed essentially of cardboard. Certain embodiments where in the tube 1 is composed essentially of cardboard include non-corrugated cardboard because a smooth and uniform finish of a column is often desirable.

In certain embodiments, the tube 1 may be a pipe or similar rigid tube. In such embodiments, the tube will comprise a pipe composed of metal, metal alloys, plastic, polyvinyl chloride, or any similar material.

Certain embodiments include a coating 5 in the inner surface 3 of the tube 1. In certain embodiments, the coating exists to prevent the inner surface 3 from sticking to a finished column 6.

A method for using the circumferential lines 4 to cut the tube to a desired length begins with a user determining the desired length. The user then selects the circumferential line 4 corresponding to the desired length. The user may then cut along the circumferential line 4.

A method for using the pairs of the diametrically opposed lines 5 begins with a user determining it is desirable to create two holes at diametrically opposed points on the tube 1. The user may then drill along each diametrically opposed line 5 of the pair. Alternatively, a user may determine a feature should be placed at a point diametrically opposed to another feature. In certain embodiments, perpendicular circumferential lines 4 intersecting the diametrically opposed lines 5 can provide a user with additional guidance to ensure level placement at a desired length on the tube 1.

FIG. 4 illustrates an embodiment for a method for using the tube 1 to form a column. The user first determines the desired height of the column 10. The desired height of the column will correspond to the desired length of the tube 1. The user then locates a circumferential line 4 on the outer surface 2 that corresponds to the desired length. The user then cuts the tube circumferentially along a circumferential line 4. The circumferential line 4 serves not only as a guide for length, but also serves as a guide when the tube 1 is cut. Using the circumferential line 4 as a guide for cutting the tube 1 ensures a clean and uniform cut of the tube 1. This will result in a uniform, level resulting column 10. After the tube 1 has been circumferentially cut, the tube is then placed on a flat surface such as the ground 7 or another suitable surface. A liquid, semi liquid, powder, or soft material 9 is then poured into the lumen 8 of the tube 1. In certain embodiments, concrete is the material poured into the lumen 8 of the tube 1. The material is then allowed to set. In certain embodiments, the tube 1 remains in place while the material 7 hardens. In other embodiments, the 1 tube may be removed before the material 9 has fully hardened. After the material 7 hardens, a finished column 10 is formed. In certain embodiments, the tube 1 is cut away from the column 10. In other embodiments, the tube 1 is simply lifted away from the column 10. Such cuts are made with a sharp object, with the direction of the cut being perpendicular to the circumferential lines 4.

Another embodiment for a method of using the tube 1 is for the purpose of cutting a pipe 11 into a desired length, as illustrated in FIG. 5. In such embodiments, a tube 1, having a diameter slightly larger than the diameter of the outer surface of a pipe 9, is placed over a pipe 9, such that the pipe is in the lumen 8 of the tube 1. A determination of made by a user of a desired length of the pipe. A circumferential line 4, corresponding to the desired length of the pipe 9 is selected. A cut is then made, along the circumferential line, cutting through both the tube 1 and the pipe 9.

While the invention has been described and illustrated with reference to certain particular embodiments thereof, those skilled in the art will appreciate that the various adaptations, changes, modifications, substitutions, deletions, or additions or procedures and protocols may be made without departing from the spirit and scope of the invention. It is intended, therefore, that the invention be defined by the scope of the claims that follow and that such claims be interpreted as broadly as reasonable.

1. A tube comprising:
an inner surface;
an outer surface;
a lumen defined by the inner surface; and
circumferential lines disposed on the outer surface of the tube.

2. The tube of claim 1 wherein the circumferential lines of a type are disposed at fixed distances from circumferential lines of the same type.

3. The tube of claim 2 wherein the tube is composed essentially of cardboard.

4. The tube of claim 2 wherein the circumferential lines disposed on the outer surface of the tube are ink or paint.

5. The tube of claim 2 wherein the circumferential lines disposed on the outer surface of the tube are embossed into the outer surface of the tube.

6. The tube of claim 2 wherein the inner surface of the tube includes a coating.

7. The tube of claim 2 wherein the tube is a pipe.

8. A tube comprising:
an inner surface;
an outer surface;
a lumen defined by the inner surface; and
a pair of diametrically opposed lines, disposed on the outer surface of the tube.

9. The tube of claim 8 wherein the tube is composed essentially of cardboard.

10. The tube of claim 9 wherein the diametrically opposed lines are disposed on the outer surface of the tube are ink or paint.

11. The tube of claim 9 wherein the diametrically opposed lines disposed on the outer surface of the tube are embossed on the outer surface on the tube.

12. The tube of claim 9 wherein the inner surface of the tube includes a coating.

13. A tube comprising:
an inner surface;
an outer surface;
a lumen defined by the inner surface;
circumferential lines disposed on the outer surface of the tube; and
a pair of diametrically opposed lines, disposed on the outer surface of the tube.

14. The tube of claim 13 wherein the circumferential lines of a type are disposed at fixed distances from circumferential lines of the same type.

15. The tube of claim 14 wherein the tube is composed essentially of cardboard.

16. The tube of claim 14 wherein the diametrically opposed lines and the diametrically opposed lines are disposed on the outer surface of the tube are ink or paint.

17. A method of forming a column, using a tube having circumferential lines comprising the steps of:
determining a desired height of a column to be formed;
selecting a circumferential line corresponding to the desired length of the column to be formed;
cutting a tube along the selected circumferential line with a cutting instrument;
placing the tube on a flat surface;
pouring a liquid or semi-liquid material into a lumen of the tube;
allowing the liquid or semi-liquid material to harden; and
removing the tube from the column formed from the hardened liquid or semi-liquid material.

18. The method of forming a column, using a tube having circumferential lines of claim 17 wherein the liquid or semi-liquid material is concrete.

19. The method of forming a column, using a tube having circumferential lines of claim 17 wherein the tube is composed essentially of cardboard.

20. The method of forming a column, using a tube having circumferential lines of claim 17 wherein the cutting instrument is a saw or a knife.
